(19) United States
(12) Patent Application Publication
(10) Pub. No.: US 2026/0316638 A1
(43) Pub. Date: Oct. 15, 2026

(54) SEAT RAIL LOCKING DEVICE

(71) Applicant: Hyundai Transys Inc., Seosan-si (KR)

(72) Inventor: Cheon KIM, Hwaseong-si (KR)

(21) Appl. No.: 19/550,781

(22) Filed: Feb. 26, 2026

(30) Foreign Application Priority Data
Apr. 11, 2025 (KR) 10-2025-0047396

(51) Int. Cl. B60N 2/08

(52) U.S. Cl. CPC B60N 2/0818; B60N 2/0875

(57) ABSTRACT

A seat rail locking device includes a hinge shaft rotatably supported by an upper rail, a pressing member connected to a lower portion of the hinge shaft inside the upper rail and configured to be rotatable together with the hinge shaft, and a locking plate elastically supported by a first elastic member and configured to be rotated in a locking direction by being pressed by the pressing member so that a locking protrusion provided on one side surface of the locking plate is inserted into a locking hole of a lower rail.

### CROSS-REFERENCE TO RELATED APPLICATIONS

This application claims priority to and the benefit of Korean Patent Application No. 10-2025-0047396 filed in the Korean Intellectual Property Office on Apr. 11, 2025, the entire contents of which are incorporated herein by reference.

### TECHNICAL FIELD

The present disclosure relates to a seat rail locking device mounted in a vehicle interior.

### BACKGROUND

In general, a seat rail may be mounted in a vehicle interior. The seat rail may include a lower rail and an upper rail. The lower rail may be mounted on a floor panel in the vehicle interior. The upper rail may be connected to a seat. The upper rail may slide along the lower rail in a state in which the upper rail is inserted into the lower rail.

The upper rail and the lower rail may be formed by roll-forming. The upper rails and the lower rails may be mass-produced by roll-forming, thereby significantly reducing manufacturing costs. However, in a case in which the upper rail and the lower rail are formed and manufactured by roll-forming, the upper rail and the lower rail are repeatedly bent, which may cause a situation in which a locking hole is not properly formed in a sidewall of the lower rail.

The lower rail, which is mounted on the floor panel in the vehicle interior, and the upper rail, which is assembled with the lower rail and configured to slide along the lower rail, may be locked by a locking device.

However, because the seat rail locking device in the related art is not equipped with a separate device that may be accurately locked, the seat rail cannot be smoothly locked due to clearance during a locking operation.

### Document of Related Art

### Patent Document

(Patent Document 1) Korean Patent Application Laid-Open No. 10-2024-0044881 (published on Apr. 5, 2024)

### SUMMARY

The present disclosure has been made in an effort to solve the above-mentioned problem, and an object of the present disclosure is to provide a seat rail locking device capable of smoothly locking an upper rail and a lower rail without clearance during a locking operation.

In order to achieve the above-mentioned object, the present disclosure provides a seat rail locking device that may include: a hinge shaft rotatably supported by an upper rail; a pressing member connected to a lower portion of the hinge shaft inside the upper rail and rotatable together with the hinge shaft; and at least one locking plate, each locking plate including a locking protrusion disposed on one side surface thereof, each locking plate being elastically supported by at least one first elastic member, each locking plate being configured to be pushed in a first locking direction by being pressed by the pressing member such that the locking protrusion is inserted into a locking hole of a lower rail.

In addition, when the pressing member rotates in a second locking direction, the pressing member may be configured to apply a pressing force of the pressing member to the at least one locking plate, the at least one locking plate may be configured to be pushed in the first locking direction, and the locking protrusion may be configured to be inserted into the locking hole defined in a sidewall of the lower rail.

In addition, when the pressing member rotates in a first unlocking direction, the pressing member may be configured to remove a pressing force of the pressing member applied to the locking plate, the at least one locking plate may be configured to be pushed in a second unlocking direction by an elastic restoring force of the at least one first elastic member, and the locking protrusion may be configured to be withdrawn from the locking hole defined in a sidewall of the lower rail.

In addition, the at least one locking plate may comprise two locking plates. The pressing member may have a length and a width as defined in a plan view, the length being larger than the width, and one longitudinal end of the pressing member and another longitudinal end of the pressing member opposite to the one longitudinal end may be configured to press, in the first locking direction, the two locking plates, respectively, when the pressing member rotates in a second locking direction, the two locking plates being positioned opposite to each other.

In addition, the seat rail locking device may further include a guide member including a main body. The at least one locking plate may be disposed on the main body of the guide member, a lower portion of the upper rail may include a first assembling space and second assembling spaces positioned at two opposite longitudinal ends of the first assembling space with the first assembling space interposed therebetween, and the first assembling space may have a larger horizontal width than a horizontal width of the second assembling spaces.

In addition, the guide member may further include support members connected to the main body inside the first assembling space and positioned at two opposite longitudinal ends of the main body while facing each other.

In addition, the at least one locking plate may comprise a plurality of locking plates. The locking plates may be disposed at two opposite sides of an upper surface of the main body inside the first assembling space and positioned such that the locking protrusion of each locking plate extend beyond a peripheral boundary of the upper surface of the main body.

In addition, one longitudinal end portion of the at least one locking plate and another longitudinal end portion of the at least one locking plate opposite to the one longitudinal end portion may be inserted into guide grooves defined in the support members.

In addition, the guide member may further include: at least one pair of catching projections disposed on the main body; and insertion spaces defined between an upper surface of the main body and the at least one pair of catching projections, respectively, and the at least one locking plate may be configured to move in the first locking direction while being guided by the at least one pair of catching projections in a state in which another side surface of the at least one locking plate opposite to the one side surface of the at least one locking plate is inserted into the insertion spaces.

In addition, the hinge shaft may include an enlarged portion disposed on a lower outer-diameter portion of the hinge shaft, the enlarged portion is positioned above the at least one locking plate to restrict an upward movement of the at least one locking plate as the at least one locking plate is caught by the enlarged portion, a coupling hole may be defined in a bottom surface of the enlarged portion, the pressing member may include a coupling protrusion disposed on one surface of the pressing member, and a coupling member may penetrate the coupling protrusion and the coupling hole from another surface of the pressing member opposite to the one surface of the pressing member and be screw-coupled to the hinge shaft in a state in which the coupling protrusion is coupled to the coupling hole.

In addition, at least a part of a lateral surface of the coupling protrusion may have a flat surface, and at least a part of the coupling hole may have a flat surface corresponding to the flat surface of the coupling protrusion.

In addition, the main body may include an accommodation hole defined at a central portion of the main body. A head portion of the coupling member may be rotatably disposed in the accommodation hole.

In addition, the at least one first elastic member may include a plurality of first elastic members. Each of the at least one locking plate may include: through-holes defined in two opposite longitudinal end portions, the plurality of first elastic members are disposed through the through-holes; and an accommodation groove defined in another side surface of each locking plate such that the pressing member is disposed in the accommodation groove.

In addition, the at least one locking plate may include two locking plates disposed on two opposite sides of an upper surface of the main body, respectively. An accommodation space, which conforms to a width of the pressing member, may be defined by accommodation grooves of the two locking plates disposed to correspond to each other.

In addition, the main body and each of the support members may be connected by a connection portion and by catching shafts disposed at two opposite sides of the connection portion, and each first elastic member may be disposed such that one end of each first elastic member is disposed in each of the through-holes and a hook positioned at another end of each first elastic member is caught by each of the catching shafts.

In addition, an upper portion of the hinge shaft may be rotatably supported by at least one support frame coupled to the upper rail, a lever elastically supported by a second elastic member may be coupled to the upper portion of the hinge shaft exposed from an upper portion of the upper rail, the lever may be connected to a pulling member and configured to transmit a rotational force to the hinge shaft while rotating in a second locking direction when the pulling member is pulled, and the lever may be configured to be returned to an original position by an elastic restoring force of the second elastic member when a force for pulling the pulling member is removed.

In addition, a guide hole is defined in a sidewall of the upper rail at a position corresponding to the first assembling space, the guide hole may conform to the locking hole defined in a sidewall of the lower rail, and the locking protrusion may be configured to be inserted into the guide hole and the locking hole while penetrating the guide hole and the locking hole during a locking operation of the at least one locking plate.

In addition, the sidewall of the upper rail at the position corresponding to the first assembling space may protrude in a direction toward the sidewall of the lower rail.

In addition, the main body and each of the support members may be connected by a third elastic member.

In addition, two opposite ends of the third elastic member may be coupled to assembling holes defined in a surface of the main body and a surface of each of the support members that face each other.

According to the present disclosure, the locking plates slide in the locking direction while being guided by the guide member in the state in which the locking plates are seated on the guide member, such that the locking operation may be perfectly controlled.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a perspective view illustrating a seat rail locking device according to an exemplary embodiment of the present disclosure.

FIG. 2 is an exploded perspective view illustrating a hinge shaft, a pressing member, a coupling member, and a guide member according to the exemplary embodiment of the present disclosure.

FIG. 3 is a view illustrating a state in which a head portion of a coupling member according to the exemplary embodiment of the present disclosure is inserted into an accommodation hole.

FIG. 4 is an exploded perspective view illustrating the hinge shaft, locking plates, and the guide member according to the exemplary embodiment of the present disclosure.

FIG. 5 is a perspective view illustrating a state in which locking protrusions according to the exemplary embodiment of the present disclosure are inserted into locking holes.

FIG. 6 is a cross-sectional view taken along line A-A in FIG. 5.

FIG. 7 is an enlarged view illustrating a lever according to the exemplary embodiment of the present disclosure.

FIG. 8 is a perspective view illustrating a state before locking according to the exemplary embodiment of the present disclosure.

FIG. 9 is a top plan view illustrating the locking plates in the state before locking according to the exemplary embodiment of the present disclosure.

FIG. 10 is a cross-sectional view taken along line B-B in FIG. 8.

FIG. 11 is a top plan view illustrating an operation of the locking plates during locking according to the exemplary embodiment of the present disclosure.

It should be understood that the appended drawings are not necessarily to scale, presenting a somewhat simplified representation of various features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings. First, in assigning reference numerals to constituent elements of the respective drawings, it should be noted that the same constituent elements will be designated by the same reference numerals, if possible, even though the constituent elements are illustrated in different drawings. In addition, in the description of the present disclosure, the specific descriptions of publicly known related configurations or functions will be omitted when it is determined that the specific descriptions may obscure the subject matter of the present disclosure. Further, the exemplary embodiments of the present disclosure will be described below, but the technical spirit of the present disclosure is not limited thereto and may, of course, be modified and variously carried out by those skilled in the art.

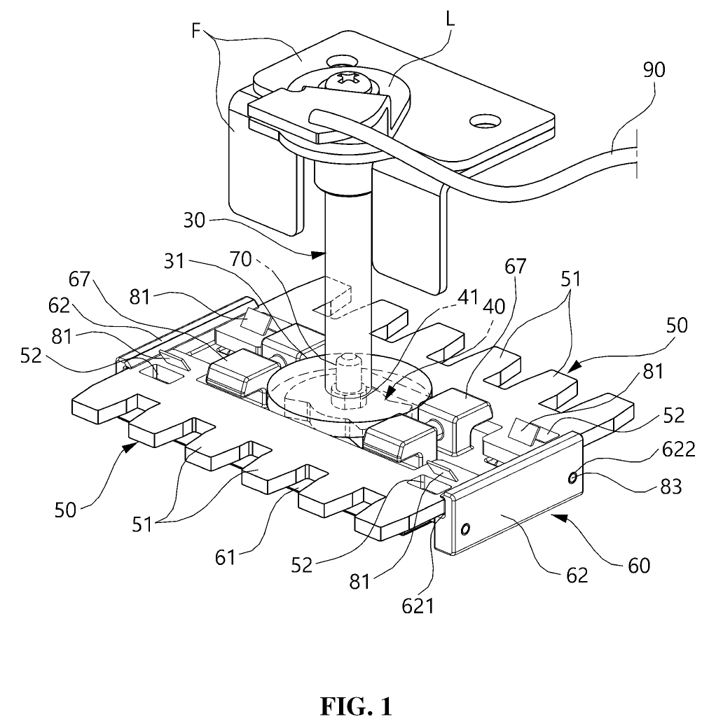

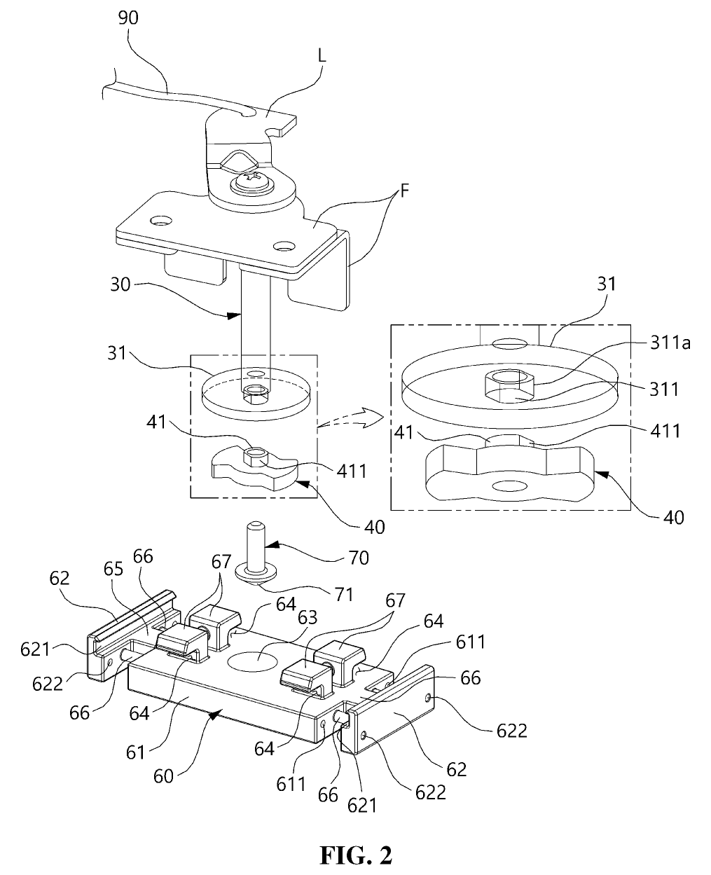

FIG. 1 is a perspective view illustrating a seat rail locking device according to an exemplary embodiment of the present disclosure. FIG. 2 is an exploded perspective view illustrating a hinge shaft, a pressing member, a coupling member, and a guide member according to the exemplary embodiment of the present disclosure.

As illustrated in FIGS. 1 and 2, the seat rail locking device may include a hinge shaft 30 configured to be rotated in a locking direction by a rotational operation of a lever L, a pressing member 40 provided in an upper rail 10 and coupled to a lower portion of the hinge shaft 30, locking plates 50 configured to be pushed in the locking direction by the pressing member 40, a guide member 60 configured such that the locking plates 50 are seated at two opposite left and right sides of an upper surface of the guide member 60 while facing each other, first elastic members 81, a second elastic member 82, and third elastic members 83.

The lower portion of the hinge shaft 30 may penetrate the upper rail 10 and be positioned in the upper rail 10. An upper portion of the hinge shaft 30 may be rotatably supported by the upper rail 10.

The hinge shaft 30 may be provided with an enlarged portion 31. The enlarged portion 31 may be provided on a lower outer-diameter portion of the hinge shaft 30. The enlarged portion 31 may be positioned above the locking plates 50 provided at two opposite left and right sides of the guide member 60.

An upward movement of the locking plates 50 may be restricted as the locking plates 50 are caught by the enlarged portion 31. As a result, a stable locking operation of the locking plates 50 may be performed.

A coupling hole 311 may be provided in a bottom surface of the enlarged portion 31. A coupling protrusion 41 may be coupled to the coupling hole 311. The coupling protrusion 41 may protrude from an upper surface of the pressing member 40.

At least a part of an outer-diameter portion of the coupling protrusion 41 may be configured as a flat surface 411.

At least a part of the coupling hole 311, which corresponds to the flat surface 411 of the coupling protrusion 41, may be configured as a flat surface 311a.

As described above, the coupling hole 311 and the coupling protrusion 41 are respectively provided with the flat surfaces 311a and 411, such that the pressing member 40 may rotate together with the hinge shaft 30 when a rotational force applied to the hinge shaft 30 is applied to the pressing member 40.

A coupling member 70 may be coupled to the coupling hole 311 in the state in which the coupling protrusion 41 is coupled to the coupling hole 311. The coupling member 70 may penetrate a center of the coupling protrusion 41 and a center of the coupling hole 311 from a bottom surface of the pressing member 40 and be screw-coupled to the hinge shaft 30. The coupling member 70 may be a bolt.

Because the pressing member 40 is securely coupled to the hinge shaft 30 by the coupling member 70, the rotational force applied to the hinge shaft 30 may be transmitted to the pressing member 40, and the pressing member 40 may rotate together with the hinge shaft 30.

The pressing member 40 may be configured in a shape in which a length thereof is larger than a width thereof. The pressing member 40 may be positioned between the locking plates 50 disposed at two opposite sides.

When the pressing member 40 rotates in the locking direction, one longitudinal end and the other longitudinal end of the pressing member 40 may press, in the locking direction, the locking plates 50 seated at two opposite sides of a main body 61 of the guide member 60.

The guide member 60 may include the main body 61, support members 62 provided at two opposite longitudinal end portions of the main body 61, catching projections 67 provided on an upper surface of the main body 61, and insertion spaces 64 formed between the catching projections 67 and the upper surface of the main body 61.

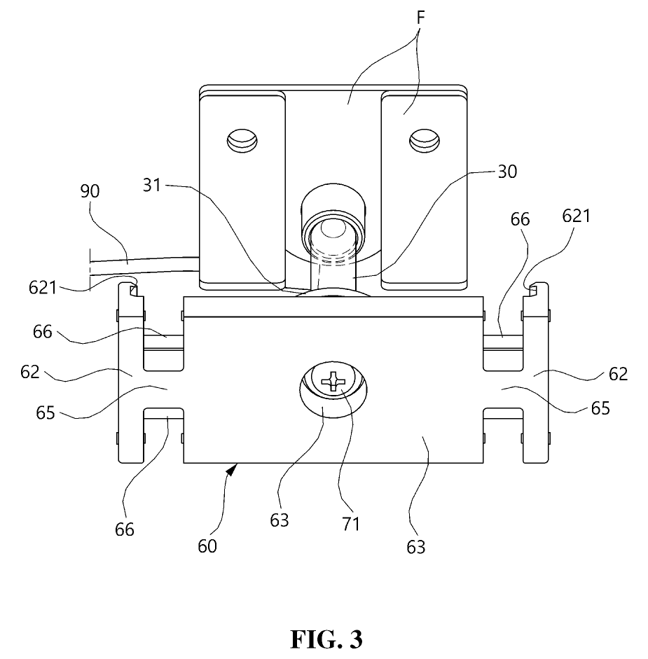

FIG. 3 is a view illustrating a state in which a head portion of the coupling member according to the exemplary embodiment of the present disclosure is inserted into an accommodation hole.

As illustrated in FIG. 3, an accommodation hole 63 may be provided at a center of the main body 61. A head portion 71 of the coupling member 70 may be inserted into the accommodation hole 63 provided at the center of the main body 61. When the pressing member 40 rotates, the head portion 71 of the coupling member 70 may freely rotate in the state in which the head portion 71 of the coupling member 70 is inserted into the accommodation hole 63.

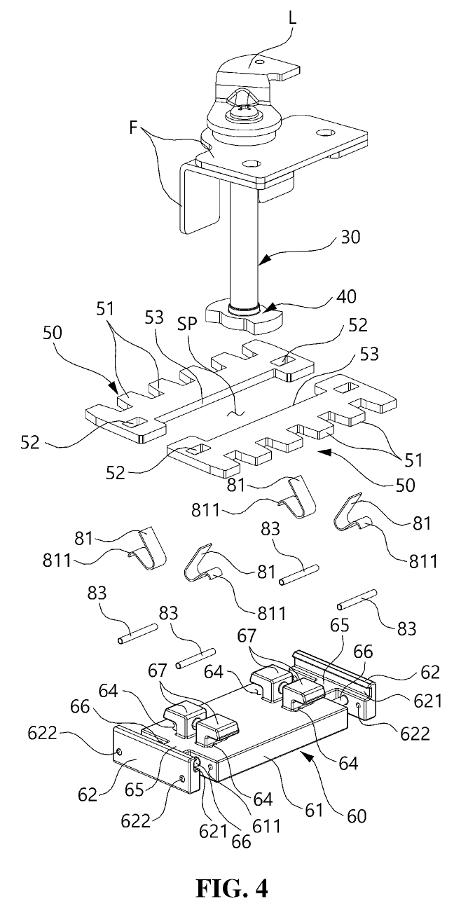

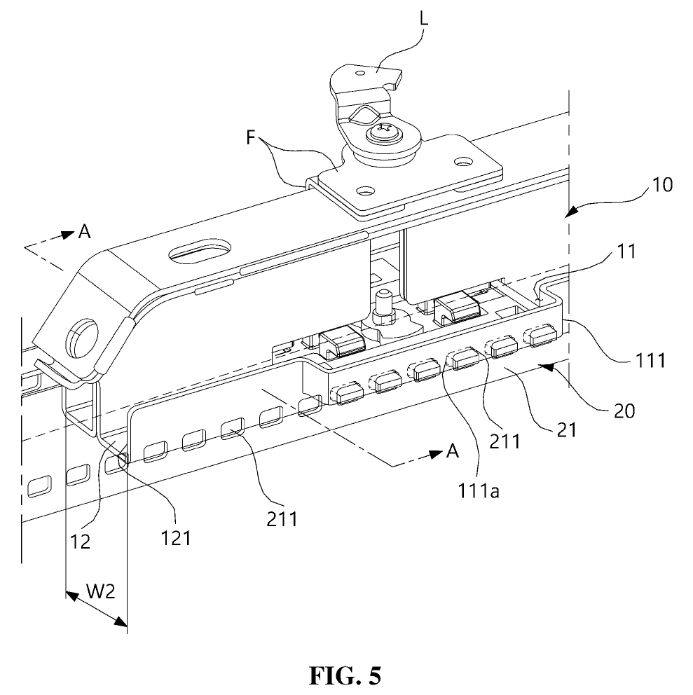

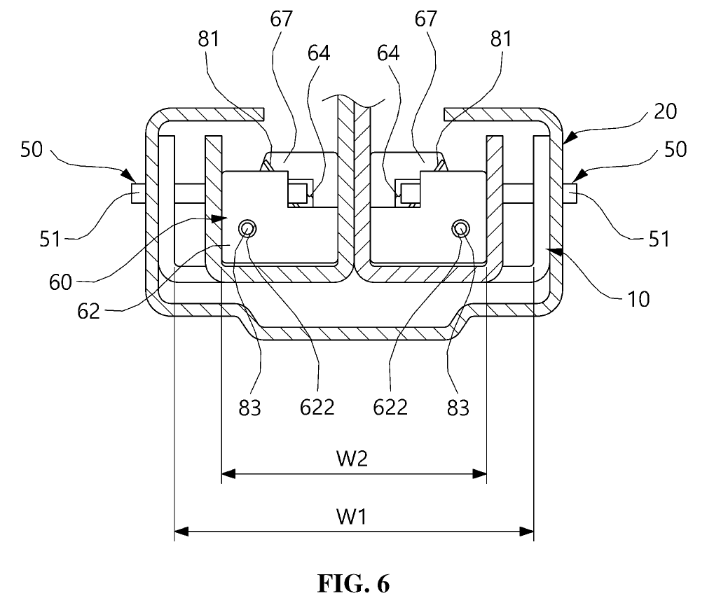

FIG. 4 is an exploded perspective view illustrating the hinge shaft, the locking plates, and the guide member according to the exemplary embodiment of the present disclosure. FIG. 5 is a perspective view illustrating a state in which locking protrusions according to the exemplary embodiment of the present disclosure are inserted into locking holes. FIG. 6 is a cross-sectional view taken along line A-A in FIG. 5.

As illustrated in FIGS. 4 to 6, the locking plates 50 may perform the locking operation by being pressed by the pressing member 40 in the state in which the locking plates 50 are seated at two opposite left and right sides of the upper surface of the main body 61 of the guide member 60. The locking plates 50 may be elastically supported by the first elastic members 81. The first elastic member 81 may be a spring.

When the pressing member 40 rotates in the locking direction, the locking plates 50 are pushed in the locking direction by the pressing member 40, and locking protrusions 51 provided on side surfaces of the locking plates 50 are inserted into locking holes 211 provided in sidewalls 21 of a lower rail 20, such that a locked state in which the upper rail 10 cannot move along the lower rail 20 may be implemented.

When a pressing force of the pressing member 40 is eliminated as the pressing member 40 rotates in an unlocking direction, the locking protrusions 51 of the locking plates 50, which are inserted into the locking holes 211, are withdrawn from the locking holes 211 by elastic restoring forces of the first elastic members 81, such that an unlocked state in which the upper rail 10 may move along the lower rail 20 may be implemented.

The upper rail 10 may slide along the lower rail 20 in a state in which the upper rail 10 is inserted into the lower rail 20. A lower portion of the upper rail 10 and an inner bottom of the lower rail 20 may be spaced apart from each other by various publicly-known structures or various publicly-known components, such as rollers.

The lower portion of the upper rail 10 may be provided with a first assembling space 11, and second assembling spaces 12 provided at two opposite longitudinal ends of the first assembling space 11 with the first assembling space 11 interposed therebetween. A horizontal width W1 of the first assembling space 11 may be configured as a width larger than a horizontal width W2 of the second assembling space 12.

Because the locking protrusions 51 of the locking plates 50 seated at the two opposite sides of the upper surface of the main body 61 of the guide member 60 protrude further than two opposite surfaces of the main body 61, the locking plates 50 may be assembled to be positioned in the first assembling space 11 having the horizontal width W1 larger than the horizontal width W2 of the second assembling space 12.

Sidewalls 111 in a section of the first assembling space 11 of the upper rail 10 may protrude in a direction toward the sidewalls 21 of the lower rail 20.

The support members 62 may be provided at the two opposite longitudinal end portions of the main body 61 and configured to face each other. The support members 62 may be provided with guide grooves 621. The guide groove 621 may be provided in one surface of the support member 62 directed toward the main body 61.

The locking plates 50 may stably slide in the locking direction in a state in which one longitudinal end portion and the other longitudinal end portion of each of the locking plates 50 are inserted into the guide grooves 621 of the support members 62.

The main body 61 may be provided with a pair of left and right catching projections 67 at one longitudinal end portion of the main body 61, and another pair of left and right catching projections 67 may be provided at another longitudinal end portion of the main body 61. The two longitudinal end portions of the main body 61 may be opposite to each other. In a case in which the catching projections 67 are formed, the insertion spaces 64 may be formed between the upper surface of the main body 61 and the catching projections 67.

The locking plate 50 may move in the locking direction while being guided by the catching projections 67 in a state in which the other side surface of the locking plate 50 is inserted into the insertion spaces 64.

The locking plate 50 may include through-holes 52 and an accommodation groove 53. The through-holes 52 may be provided at two opposite longitudinal end portions of the locking plate 50. The first elastic members 81 may be inserted into the through-holes 52. The accommodation groove 53 may be provided on another side surface of the locking plate 50. The side surface of the locking plate 50 on which the accommodation groove 53 is provided may be opposite to the side surface of the locking plate 50 on which the locking protrusions 51 are provided.

An accommodation space SP, which conforms to a width of the pressing member 40, may be formed when the accommodation grooves 53 of the pair of left and right locking plates 50 seated at the two opposite left and right sides of the main body 61, with the catching projections 67 interposed therebetween, are disposed to correspond to each other. The catching projections 67 may be positioned inside the accommodation grooves 53 of the locking plates 50.

The main body 61 and the support members 62 may be connected by connection portions 65 and by catching shafts 66 provided at two opposite sides with the connection portions 65 interposed therebetween. The connection portion 65 may be positioned at a center of a surface of the main body 61 and a center of a surface of the support member 62 that face each other.

One end of the first elastic member 81 may be inserted into the through-hole 52 while penetrating the through-hole 52 from a bottom surface of the locking plate 50. A hook 811 may be provided at the other end of the first elastic member 81. The hook 811 may be assembled to be caught by the catching shaft 66.

As described above, the first elastic member 81 is assembled such that one end of the first elastic member 81 and the hook 811 provided at the other end of the first elastic member 81 are respectively caught by the through-hole 52 and the catching shaft 66. Therefore, the pair of left and right locking plates 50, which are seated at the two opposite sides of the main body 61 and pushed in the locking direction by being pressed by the pressing member 40, may be moved in the unlocking direction by the elastic restoring forces of the first elastic members 81 when the pressing force of the pressing member 40 is eliminated.

Guide holes 111a may be provided in the sidewalls 111 in the section of the first assembling space 11. The guide hole 111a may be configured to conform to the locking hole 211. During the locking operation of the locking plate 50, the locking protrusion 51 may be inserted into the guide hole 111a and the locking hole 211 while penetrating the guide hole 111a and the locking hole 211.

As described above, the locking protrusions 51 are simultaneously inserted into the guide holes 111a of the upper rail 10 and the locking holes 211 of the lower rail 20, such that the upper rail 10 and the lower rail 20 may be securely locked.

The main body 61 and the support members 62 may be integrated. The main body 61 and the support members 62 may be connected by the third elastic members 83. The third elastic member 83 may be a spring.

Assembling holes 611 and 622, to which the third elastic member 83 is coupled, may be provided in the surface of the main body 61 and the surface of the support member 62 that face each other. One end and the other end of the third elastic member 83 may be respectively coupled to the assembling hole 611 of the main body 61 and the assembling hole 622 of the support member 62.

For example, the support member 62 and the main body 61 may be structured to be separated from each other. Specifically, the support member 62 and the main body 61 may be connected by the third elastic member 83, such that the support member 62 may move in the longitudinal direction of the main body 61.

When the support members 62 provided at the two opposite longitudinal end portions of the main body 61 are pulled during a process of assembling the locking plate 50, the third elastic members 83 are stretched, and a distance between the support members 62 disposed at the two opposite sides is increased, such that two opposite longitudinal end portions of the locking plate 50 may be easily assembled into the guide grooves 621 of the support members 62 disposed at the two opposite sides.

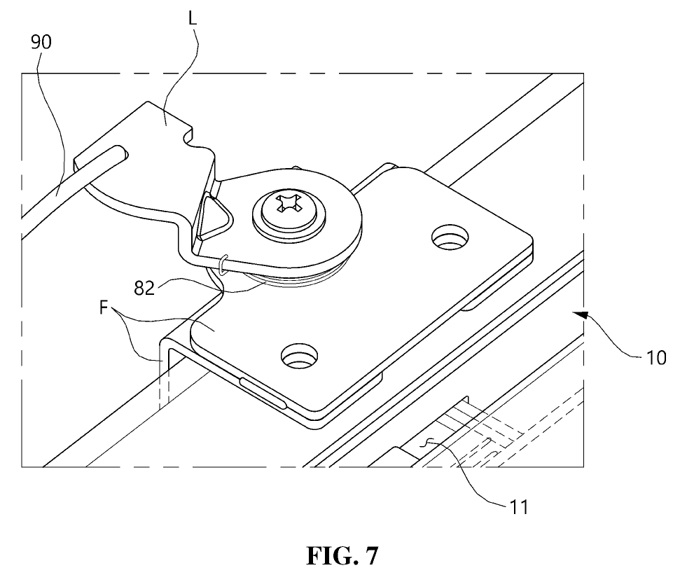

FIG. 7 is an enlarged view illustrating the lever according to the exemplary embodiment of the present disclosure.

As illustrated in FIG. 7, the upper portion of the hinge shaft 30 may be rotatably supported by at least one support frame F coupled to the upper rail 10.

The lever L may be coupled to the upper portion of the hinge shaft 30 exposed from an upper portion of the upper rail 10. The lever L may be elastically supported by the second elastic member 82. The second elastic member 82 may be a spring.

One end of the second elastic member 82 may be connected to the lever L while being coupled to the hinge shaft 30. An elastic restoring force of the second elastic member 82 may be applied to the lever L. The lever L may be connected to a pulling member 90, such as a wire.

The lever L may rotate in the locking direction during an operation of pulling the pulling member 90. When the lever L rotates in the locking direction, a rotational force of the lever L may be applied to the hinge shaft 30, such that the hinge shaft 30 may rotate in the locking direction.

When a force for pulling the pulling member 90 is eliminated, the lever L may be rotated in the unlocking direction by the elastic restoring force of the second elastic member 82. When the lever L is rotated in the unlocking direction by the elastic restoring force of the second elastic member 82, a rotational force of the lever L may be applied to the hinge shaft 30, such that the hinge shaft 30 may rotate in the unlocking direction.

Next, the unlocked state of the present disclosure will be described.

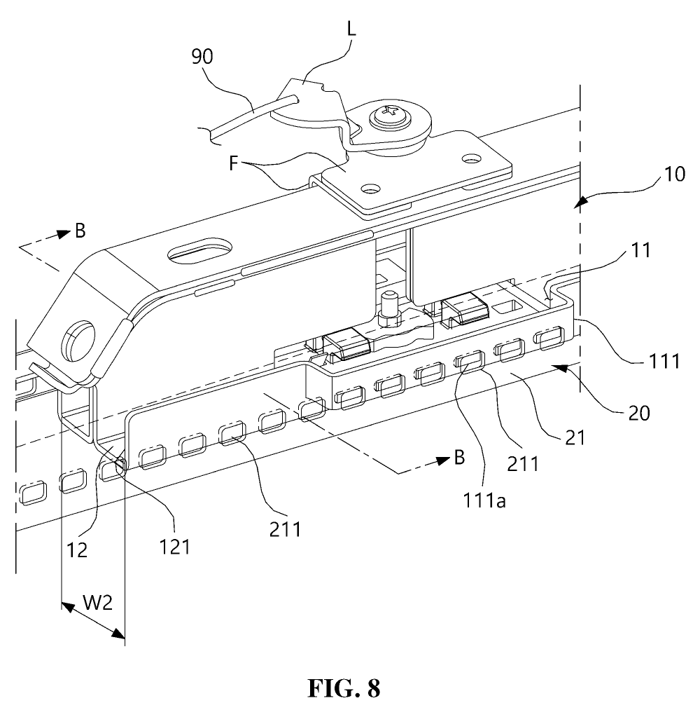

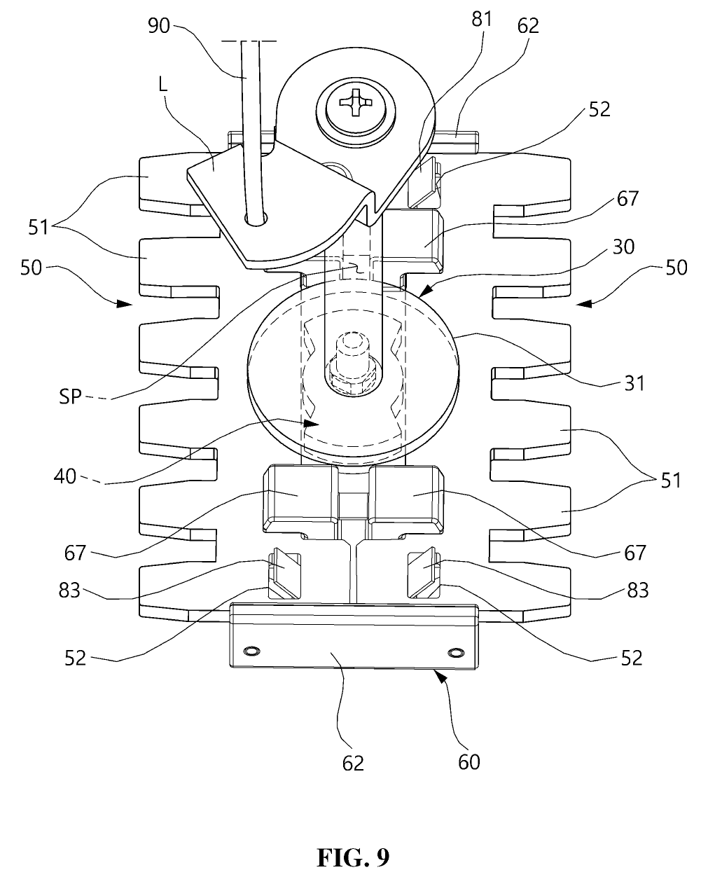

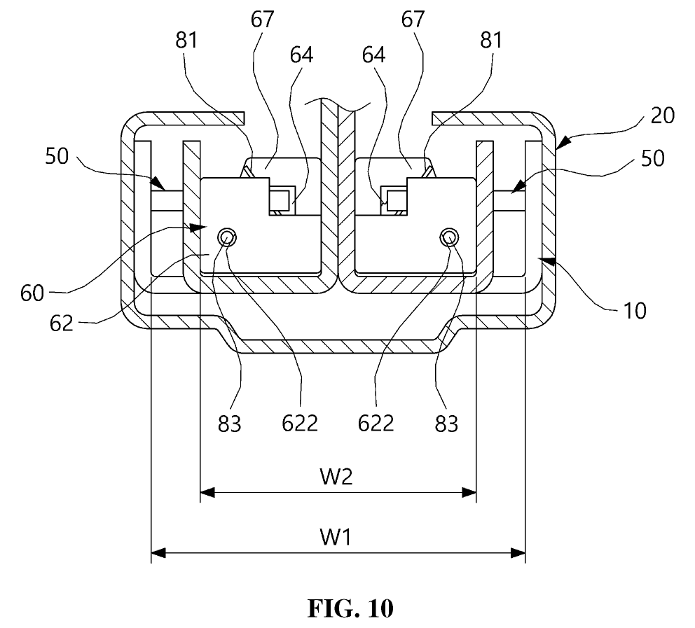

FIG. 8 is a perspective view illustrating a state before locking according to the exemplary embodiment of the present disclosure. FIG. 9 is a top plan view illustrating the locking plates in the state before locking according to the exemplary embodiment of the present disclosure. FIG. 10 is a cross-sectional view taken along line B-B in FIG. 8.

As illustrated in FIGS. 8 to 10, the lever L may be maintained in the unlocked state when the force for pulling the pulling member 90 is not being applied to the lever L. Because the lever L does not rotate, a rotational force of the lever L is not applied to the hinge shaft 30.

Because the hinge shaft 30 does not rotate, the pressing member 40 connected to the lower portion of the hinge shaft 30 does not operate.

Because a width portion of the pressing member 40 is positioned to correspond to a horizontal width of the accommodation space SP, the locking plates 50 disposed at the two opposite sides are not pushed in the locking direction.

Because the locking plates 50 disposed at the two opposite sides are not pushed in the locking direction, the unlocked state in which the locking protrusions 51 of the locking plates 50 are not inserted into the locking holes 211 may be implemented.

In the unlocked state, the upper rail 10 may freely move along the lower rail 20, such that a seat (not illustrated) of a vehicle connected to the upper rail 10 may be moved to a desired position.

Next, the locking operation of the present disclosure will be described.

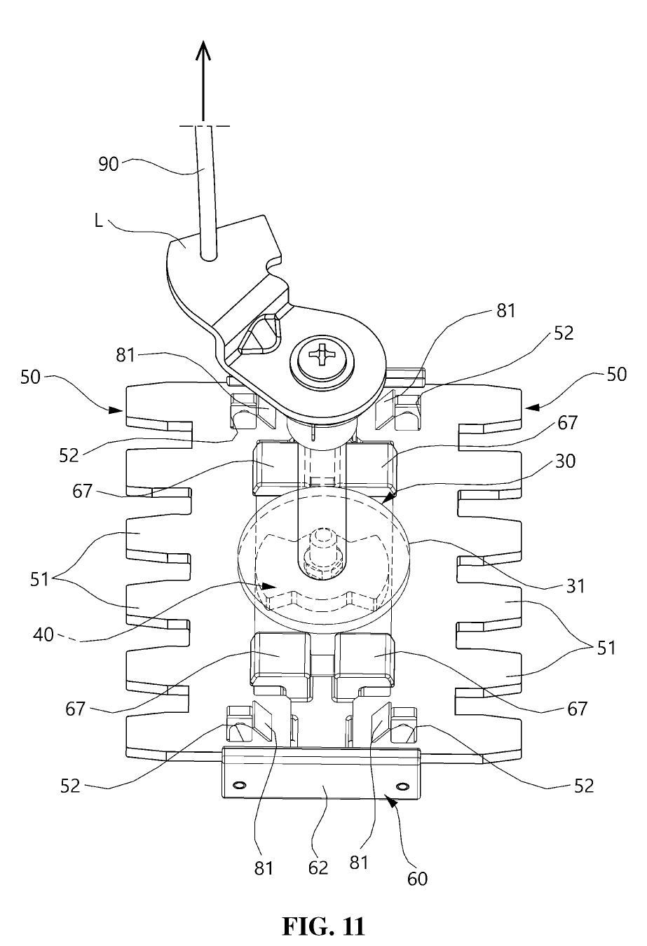

FIG. 11 is a top plan view illustrating an operation of the locking plates during locking according to the exemplary embodiment of the present disclosure.

As illustrated in FIGS. 5, 6, 11, the lever L may rotate in the locking direction when the pulling member 90 is pulled in the locking direction.

When the lever L rotates in the locking direction, a rotational force of the lever L may be applied to the hinge shaft 30, such that the hinge shaft 30 may rotate in the locking direction.

When the hinge shaft 30 rotates in the locking direction, the pressing member 40 connected to the lower portion of the hinge shaft 30 may rotate in the locking direction.

When the pressing member 40 rotates in the locking direction, one longitudinal end and the other longitudinal end of the pressing member 40 may push, in the locking direction, the locking plates 50 disposed at the two opposite sides.

When the locking plates 50 are pushed in the locking direction, the locking protrusions 51 of the locking plates 50 may be simultaneously inserted into the guide holes 111a of the upper rail 10 and the locking holes 211 of the lower rail 20. As a result, the locked state in which the upper rail 10 cannot move along the lower rail 20 may be implemented.

The locking protrusions 51 are simultaneously inserted into the guide holes 111a of the upper rail 10 and the locking holes 211 of the lower rail 20, such that the upper rail 10 and the lower rail 20 may be securely locked.

The upper portion of the locking plate 50 is supported by the enlarged portion 31, and one longitudinal end portion and the other longitudinal end portion of the locking plate 50 slide in the locking direction along the guide grooves 621 of the support members 62, such that a smooth locking operation may be performed without clearance.

When the force for pulling the pulling member 90 is eliminated, the lever L may be rotated in the unlocking direction and returned to an original position by the elastic restoring force of the second elastic member 82.

The hinge shaft 30 may rotate in the unlocking direction as the lever L rotates in the unlocking direction.

When the hinge shaft 30 rotates in the unlocking direction, the pressing member 40 connected to the lower portion of the hinge shaft 30 may rotate in the unlocking direction together with the hinge shaft 30.

When the pressing member 40 rotates in the unlocking direction, the pressing force of the pressing member 40 applied to the locking plates 50 disposed at the two opposite sides may be eliminated.

When the pressing force of the pressing member 40 applied to the locking plates 50 is eliminated, the locking plates 50 may be returned to the original position by the elastic restoring forces of the first elastic members 81.

When the locking plates 50 are returned to the original position, the locking protrusions 51 inserted into the locking holes 211 may be withdrawn from the locking holes 211, such that the unlocked state in which the upper rail 10 may freely move along the lower rail 20 may be implemented.

The above description is simply given for illustratively describing the technical spirit of the present disclosure, and those skilled in the art to which the present disclosure pertains will appreciate that various modifications, changes, and substitutions are possible without departing from the essential characteristics of the present disclosure. Accordingly, the embodiments disclosed in the present disclosure and the accompanying drawings are intended not to limit but to describe the technical spirit of the present disclosure, and the scope of the technical spirit of the present disclosure is not limited by the embodiments and the accompanying drawings. The protective scope of the present disclosure should be construed based on the following claims, and all the technical spirit in the equivalent scope thereto should be construed as falling within the scope of the present disclosure.

As described above, the exemplary embodiments have been described and illustrated in the drawings and the specification. The exemplary embodiments were chosen and described in order to explain certain principles of the disclosure and their practical application, to thereby enable others skilled in the art to make and utilize various exemplary embodiments of the present disclosure, as well as various alternatives and modifications thereof. As is evident from the foregoing description, certain aspects of the present disclosure are not limited by the particular details of the examples illustrated herein, and it is therefore contemplated that other modifications and applications, or equivalents thereof, will occur to those skilled in the art. Many changes, modifications, variations and other uses and applications of the present construction will, however, become apparent to those skilled in the art after considering the specification and the accompanying drawings. All such changes, modifications, variations and other uses and applications which do not depart from the spirit and scope of the disclosure are deemed to be covered by the disclosure which is limited only by the claims which follow.

### DESCRIPTION OF REFERENCE NUMERALS

10: Upper rail

11: First assembling space

111: Sidewall

111a: Guide hole

12: Second assembling space

121: Sidewall

20: Lower rail

21: Sidewall

211: Locking hole

30: Hinge shaft

31: Enlarged portion

311: Coupling hole

311a: Flat surface

40: Pressing member

41: Coupling protrusion

411: Flat surface

50: Locking plate

51: Locking protrusion

52: Through-hole

53: Accommodation groove

60: Guide member

61: Main body

611: Assembling hole

62: Support member

621: Guide groove

622: Assembling hole

63: Accommodation hole

64: Insertion space

65: Connection portion

66: Catching shaft

67: Catching projection

70: Coupling member

71: Head portion

81: First elastic member

811: Hook

82: Second elastic member

83: Third elastic member

90: Pulling member

F: Support frame

L: Lever

SP: Accommodation space

W1: Horizontal width

W2: Horizontal width

What is claimed is:

1. A seat rail locking device, comprising:
a hinge shaft rotatably supported by an upper rail;
a pressing member connected to a lower portion of the hinge shaft inside the upper rail and rotatable together with the hinge shaft; and
at least one locking plate, each locking plate including a locking protrusion disposed on one side surface thereof, each locking plate being elastically supported by at least one first elastic member, each locking plate being configured to be pushed in a first locking direction by being pressed by the pressing member such that the locking protrusion is inserted into a locking hole of a lower rail.

2. The seat rail locking device of claim 1, wherein when the pressing member rotates in a second locking direction, the pressing member is configured to apply a pressing force of the pressing member to the at least one locking plate, the at least one locking plate is configured to be pushed in the first locking direction, and the locking protrusion is configured to be inserted into the locking hole defined in a sidewall of the lower rail.

3. The seat rail locking device of claim 1, wherein when the pressing member rotates in a first unlocking direction, the pressing member is configured to remove a pressing force of the pressing member applied to the at least one locking plate, the at least one locking plate is configured to be pushed in a second unlocking direction by an elastic restoring force of the at least one first elastic member, and the locking protrusion is configured to be withdrawn from the locking hole defined in a sidewall of the lower rail.

4. The seat rail locking device of claim 1,
wherein the at least one locking plate comprises two locking plates,
wherein the pressing member has a length and a width as defined in a plan view, the length being larger than the width, and
wherein one longitudinal end of the pressing member and another longitudinal end of the pressing member opposite to the one longitudinal end are configured to press, in the first locking direction, the two locking plates, respectively, when the pressing member rotates in a second locking direction, the two locking plates being positioned opposite to each other.

5. The seat rail locking device of claim 1, further comprising:
a guide member including a main body,
wherein the at least one locking plate is disposed on the main body of the guide member,
wherein a lower portion of the upper rail include a first assembling space and second assembling spaces positioned at two opposite longitudinal ends of the first assembling space with the first assembling space interposed therebetween, and
wherein the first assembling space has a larger horizontal width than a horizontal width of each of the second assembling spaces.

6. The seat rail locking device of claim 5, wherein the guide member further comprises support members connected to the main body inside the first assembling space and positioned at two opposite longitudinal end portions of the main body while facing each other.

7. The seat rail locking device of claim 6,
wherein the at least one locking plate comprises a plurality of locking plates,
wherein the plurality of locking plates are disposed at two opposite sides of an upper surface of the main body inside the first assembling space and positioned such that the locking protrusion of each locking plate extend beyond a peripheral boundary of the upper surface of the main body.

8. The seat rail locking device of claim 6, wherein one longitudinal end portion of the at least one locking plate and another longitudinal end portion of the at least one locking plate opposite to the one longitudinal end portion are inserted into guide grooves defined in the support members.

9. The seat rail locking device of claim 6, wherein the guide member further comprises:
at least one pair of catching projections disposed on the main body; and
insertion spaces defined between an upper surface of the main body and the at least one pair of catching projections, respectively, and
wherein the at least one locking plate is configured to move in the first locking direction while being guided by the at least one pair of catching projections in a state in which another side surface of the at least one locking plate opposite to the one side surface of the at least one locking plate is inserted into the insertion spaces.

10. The seat rail locking device of claim 6,
wherein the hinge shaft includes an enlarged portion disposed on a lower outer-diameter portion of the hinge shaft,
wherein the enlarged portion is positioned above the at least one locking plate to restrict an upward movement of the at least one locking plate as the at least one locking plate is caught by the enlarged portion,
wherein a coupling hole is defined in a bottom surface of the enlarged portion, and
wherein the pressing member includes a coupling protrusion disposed on one surface of the pressing member,
wherein a coupling member penetrates the coupling protrusion and the coupling hole from another surface of the pressing member opposite to the one surface of the pressing member and is screw-coupled to the hinge shaft in a state in which the coupling protrusion is coupled to the coupling hole.

11. The seat rail locking device of claim 10, wherein at least a part of a lateral surface of the coupling protrusion has a flat surface, and at least a part of the coupling hole has a flat surface corresponding to the flat surface of the coupling protrusion.

12. The seat rail locking device of claim 10,
wherein the main body includes an accommodation hole defined at a central portion of the main body,
wherein a head portion of the coupling member is rotatably disposed in the accommodation hole of the main body.

13. The seat rail locking device of claim 6,
wherein the at least one first elastic member includes a plurality of first elastic members,
wherein each of the at least one locking plate comprises:
through-holes defined in two opposite longitudinal end portions, the plurality of first elastic members are disposed through the through-holes; and
an accommodation groove defined in another side surface of each locking plate such that the pressing member is disposed in the accommodation groove.

14. The seat rail locking device of claim 13,
wherein the at least one locking plate includes two locking plates disposed on two opposite sides of an upper surface of the main body, respectively,
wherein an accommodation space, which conforms to a width of the pressing member, is defined by accommodation grooves of the two locking plates disposed to correspond to each other.

15. The seat rail locking device of claim 14,
wherein the main body and each of the support members are connected by a connection portion and by catching shafts disposed at two opposite sides of the connection portion, and
wherein each first elastic member is disposed such that one end of each first elastic member is disposed in each of the through-holes and a hook positioned at another end of each first elastic member is caught by each of the catching shafts.

16. The seat rail locking device of claim 1,
wherein an upper portion of the hinge shaft is rotatably supported by at least one support frame coupled to the upper rail,
wherein a lever elastically supported by a second elastic member is coupled to the upper portion of the hinge shaft exposed from an upper portion of the upper rail,
wherein the lever is connected to a pulling member and configured to transmit a rotational force to the hinge shaft while rotating in a second locking direction when the pulling member is pulled, and
wherein the lever is configured to be returned to an original position by an elastic restoring force of the second elastic member when a force for pulling the pulling member is removed.

17. The seat rail locking device of claim 6,
wherein a guide hole is defined in a sidewall of the upper rail at a position corresponding to the first assembling space, the guide hole conforming to the locking hole defined in a sidewall of the lower rail, and
wherein the locking protrusion is configured to be inserted into the guide hole and the locking hole while penetrating the guide hole and the locking hole during a locking operation of the at least one locking plate.

18. The seat rail locking device of claim 17, wherein the sidewall of the upper rail at the position corresponding to the first assembling space protrudes in a direction toward the sidewall of the lower rail.

19. The seat rail locking device of claim 6, wherein the main body and each of the support members are connected by a third elastic member.

20. The seat rail locking device of claim 19, wherein two opposite ends of the third elastic member are coupled to assembling holes defined in a surface of the main body and a surface of each of the support members that face each other.
